(19) United States
(12) Patent Application Publication
(10) Pub. No.: US 2016/0315905 A1
(43) Pub. Date: Oct. 27, 2016

(54) Method and System for Determining and Tracking an Email Open Duration

(71) Applicant: Amit Gupta, San Francisco, CA (US)

(72) Inventor: Amit Gupta, San Francisco, CA (US)

(21) Appl. No.: 15/134,492

(22) Filed: Apr. 21, 2016

Related U.S. Application Data
(60) Provisional application No. 62/151,481, filed on Apr. 23, 2015.

(51) Int. Cl. H04L 12/58; H04L 29/06; H04L 29/08

(52) U.S. Cl. CPC H04L 51/34; H04L 67/02; H04L 69/16

(57) ABSTRACT

A method to determine the duration of time an email is opened for on a recipient's computer or mobile electronic device. The purpose of the present invention is to capture this timing information by modifying existing pixel tracking technology in a novel way by not actually sending back the pixel to the REC. Rather the RTS will hold open the pixel image request but not actually send any image data back. The key method step is to have the RTS do the opposite of what the REC is requesting in the HTTP application layer request by not sending any image data. While the request is held open at the HTTP layer, the RTS is giving the REC an opportunity to send a signal via the network TCP/IP layer of when the email is no longer open.

### CROSS REFERENCE TO RELATED APPLICATIONS:

This application claims priority from U.S. Patent Application Ser. No. 62/151,481, entitled “Method and System for Determining and Tracking an Email Open Duration”, filed on 23 Apr. 2015. The benefit under 35 USC §119(e) of the United States provisional application is hereby claimed, and the aforementioned application is hereby incorporated herein by reference.

### TECHNICAL FIELD OF THE INVENTION

The present invention relates generally to email applications. More specifically, the present invention relates to systems and methods for determining the duration an email has been opened on a recipient user's computer or mobile electronic device.

### BACKGROUND OF THE INVENTION

Email tracking has been in existence for many years and is widely used by email marketing companies. The primary method of tracking is by embedding a remote transparent image (i.e. a pixel) inside the body of the email that is intended to be tracked. The pixel has a

Uniform resource location (URL) that has a unique identifier (UID) associated with it. When a Recipient's Email Client (REC) loads the pixel from the Remote Tracking Server (RTS), the RTS is able to associate the UID contained in the pixel's URL to a specific email that was sent.

Currently with most email marketing companies, the RTS is generally able to determine limited information when the REC requests the pixel from the URL. The time and date when the email was opened is readily attainable. Also, the Device/Platform information (such as on a Desktop or Mobile, or Apple or PC etc.) is obtainable based on the HTTP layer UserAgent header that is provided by the email client.

Network/ISP information (e.g., On Comcast, or Verizon) is based on using the Internet Protocol (IP) address of the REC's device and looking it up against known databases that map IP addresses to Internet Service Providers (ISPs). Location information (e.g., City, State, Country, or Latitude/Longitude) is also based on the REC's IP address looked up against databases that maps the IP addresses to a physical location. The physical location is usually approximate in nature, particularly when the REC is connecting via a mobile internet connection.

This data is collected by email services providers (ESPs) such as CONSTANT CONTACT, MAILCHIMP, and others who then provide email tracking reports to their customers. No ESP or tracking company currently reports to the sender how long the email was actually opened for as a duration measurement.

For example, ESPs can not determine whether an email was open for 1 second or 15 seconds. This is due to the fact that the REC does not report back to the RTS any tracking information after the pixel is received. This information is highly valuable to certain segments of users because it helps gauge the interest level of the email recipient. DEFINITIONS

Unless stated to the contrary, for the purposes of the present disclosure, the following terms shall have the following definitions:

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society “Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

“Email” or “electronic messages” is defined as a means or system for transmitting messages electronically as between computers or mobile electronic devices on a network.

“Email Client” or more formally mail user agent (MUA) is a computer program used to access and manage a user's email. A web application that provides message management, composition, and reception functions is sometimes also considered an email client, but more commonly referred to as webmail.

“EMS” is an abbreviation for email service providers, which are companies that provide email clients enabling users to send and receive electronic messages.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

The Hypertext Transfer Protocol (HTTP) is an application protocol for distributed, collaborative, hypermedia information systems. HTTP is the foundation of data communication for the World Wide Web. Hypertext is structured text that uses logical links (hyperlinks) between nodes containing text. HTTP is the protocol to exchange or transfer hypertext.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating in the Internet.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from where ever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

“REC” or “recipient email client” is the computer program used to access and manage a user's email when that user is the recipient of the email being tracked or monitored.

“RTS” or “remote tracking server” is a third party software module stored on and executed by a computer that communicates with a recipient email client to gather information about specific emails being received.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

UID is an abbreviation for Unique Identifier, which in the present invention is a remote transparent image embedded in an email.

URL is an abbreviation of Uniform Resource Locator (URL), it is the global address of documents and other resources on the World Wide Web (also referred to as the “Internet”).

A “User” is any person registered to use the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client—server distributed computing system. In particular, the Hypertext Transfer Protocol (HTTP) identifies the client software originating the request, using a “User-Agent” header, even when the client is not operated by a user. The SIP protocol (based on HTTP) followed this usage.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

### SUMMARY OF THE INVENTION

The present invention provides a novel method to determine the duration of time an email is opened for on a recipient's computer or mobile electronic device. The purpose of the present invention is to capture this timing information by modifying existing pixel tracking technology in a novel way by not actually sending back the pixel to the REC. Rather the RTS will hold open the pixel image request but not actually send any image data back.

In a first step of the method of the present invention, the RTS starts a timer as soon as the REC request is received by the RTS. In a second step the RTS holds the delivery of the pixel to the REC rather than returning any image data by either not sending any data, or only sending HTTP header data. The delay holds the TCP/IP layer connection open. In a third step the RTS waits for the REC to close the TCP/IP connection. In a fourth step, the REC stops the timer when the RTS detects the network layer TCP/IP connection has been closed by the REC. In a fifth step the REC records the duration between the start and stop of the timer and associates it with the tracking pixel UID.

The key method step of the present invention is to have the RTS do the opposite of what the REC is requesting in the HTTP application layer request by not sending any image data.

While the request is held open at the HTTP layer, the RTS is giving the REC an opportunity to send a signal via the network TCP/IP layer of when the email is no longer open.

### BRIEF DESCRIPTION OF THE DRAWINGS

The accompanying drawings, which are incorporated herein form a part of the specification, illustrate the present invention and, together with the description, further serve to explain the principles of the invention and to enable a person skilled in the pertinent art to make and use the invention.

FIG. 1 illustrates an email body containing an image pixel.

FIG. 2 illustrates the normal communication flow between REC and RTS.

FIG. 3 illustrates the modified communication flow between REC and RTS taught by the present invention.

FIG. 4 is a flow chart illustrating how basic pixel tracking currently operates without the present invention.

FIG. 5 is a flow chart illustrating the process/method for when an REC makes a request for a pixel.

FIG. 6 is a flow chart illustrating the process/method of the RTS.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

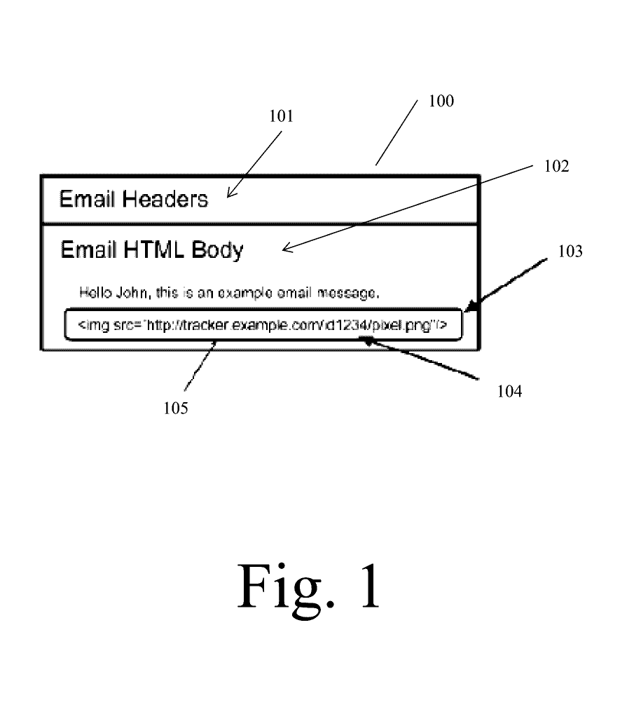

FIG. 1 illustrates an email 100 with email headers 101, an email body 102 containing an image pixel 103, the pixel's unique ID (UID) 104, and a remote tracking server (RTS) address 105.

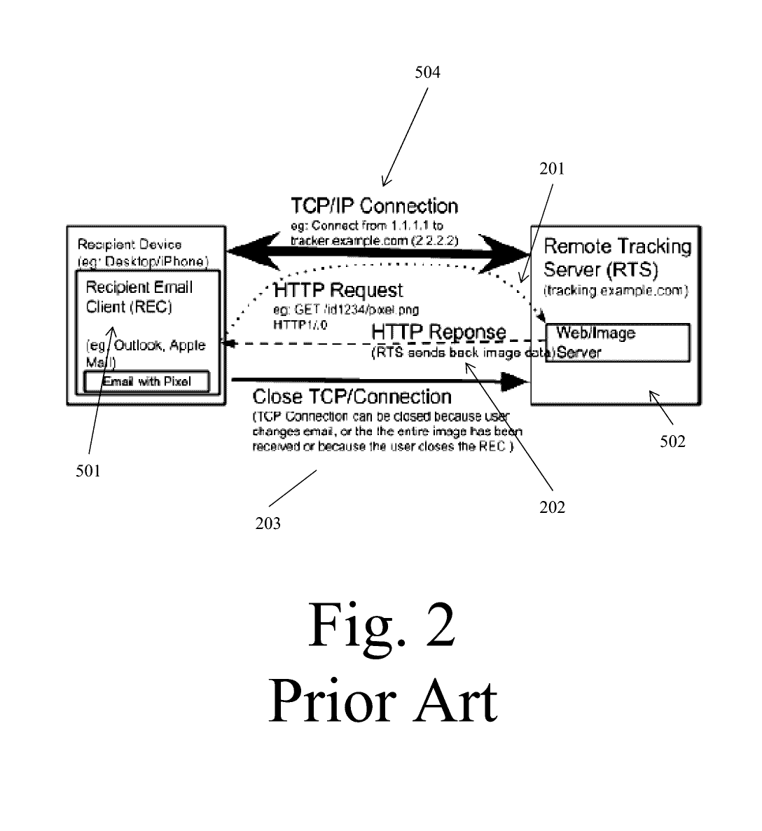

FIG. 2 illustrates the normal communication flow between the REC 501 and RTS 502. A TCP/IP connection 504 provides a connection between the REC 501 and RTS 502. The HTTP layer 506 allows the REC 501 to send a request 201 to the RTS 502 and for the RTS 502 to send a response back that includes image data 202. The TCP connection can be closed because the user changes email, or the entire image has been received or because the user closes the REC 501 in step 203.

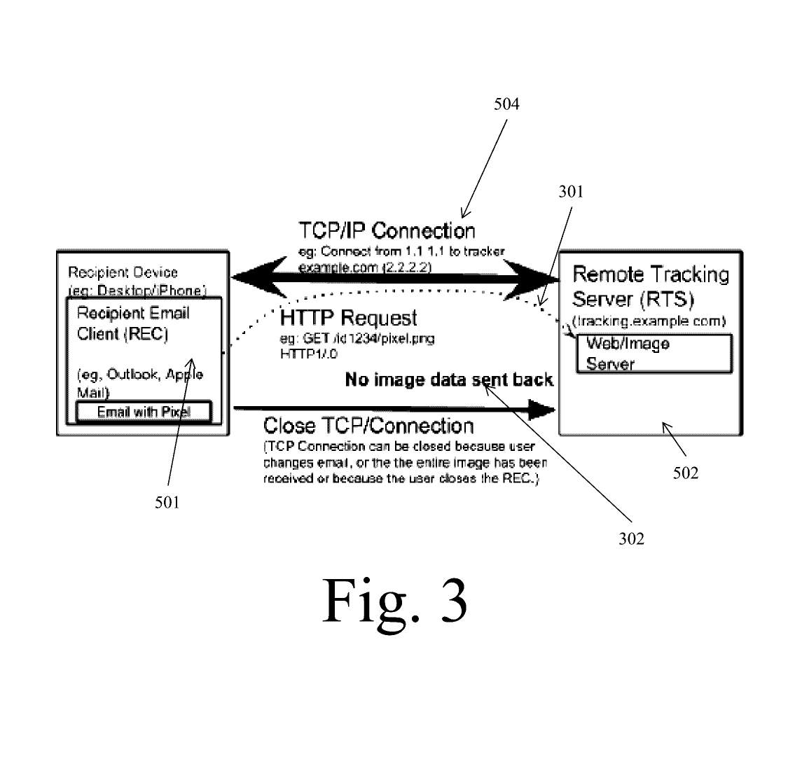

FIG. 3 illustrates the modified communication flow between REC 501 and RTS 502 taught by the present invention. A TCP/IP connection 504 provides a connection between the REC 501 and RTS 502. The HTTP layer 506 allows the REC 501 to send a request 301 to the RTS 502, but the RTS 502 does not respond or send any image data back to the REC 501 as shown by element 302. The TCP connection can be closed because the user changes email, or the entire image has been received or because the user closes the REC 501 in step 203.

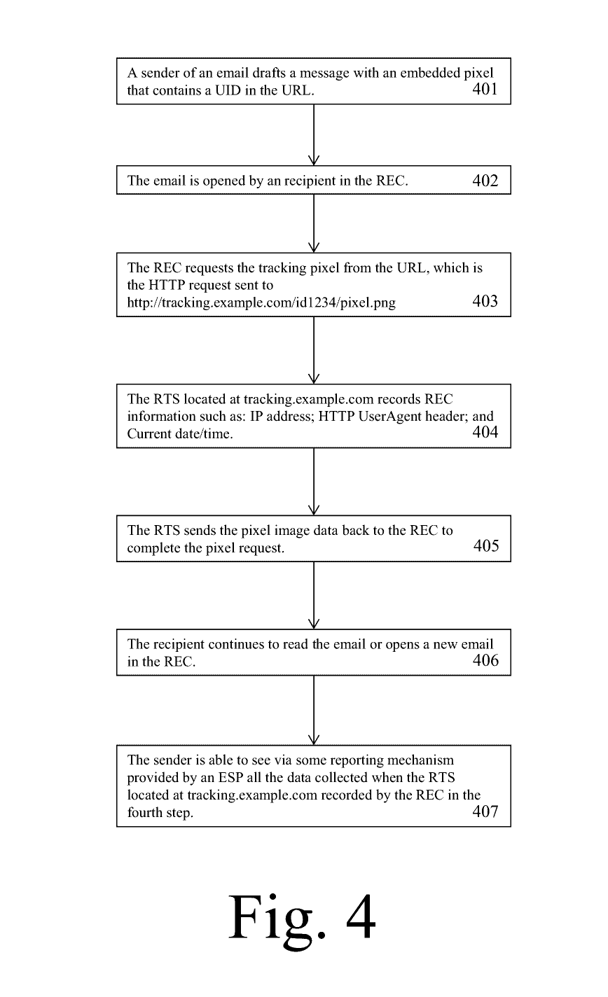

FIG. 4 is a flow chart that illustrates how basic pixel tracking currently operates without the present invention. In a first step, a sender of an email drafts a message with an embedded pixel that contains a UID in the URL 401. The URL =http://tracking.example.com/id1234/pixel.png The UID=id1234 which maps to the recipient email address. RTS=tracking.example.com and Application Protocol=HTTP. In a second step, the email is opened by an recipient in the REC 402 where REC=Outlook, Apple Mail etc. In a third step, the REC 501 requests the tracking pixel from the URL, which is the HTTP request sent to http://tracking.example.com/id1234/pixel.png 403. In a fourth step, the RTS 502 located at tracking.example.com records REC information such as: IP address; HTTP UserAgent header; and Current date/time 404.

Next, in a fifth step, the RTS sends the pixel image data back to the REC to complete the pixel request 405. In a sixth step, the recipient continues to read the email or opens a new email in the REC 406. In a seventh step the sender is able to see via some reporting mechanism provided by an ESP all the data collected 407 when the RTS 502 located at tracking.example.com recorded by the REC 501 in the fourth step.

Currently, an RTSs 502 starts to deliver a pixel's image data almost immediately back to the REC 501. Either in one data chunk, or streamed in smaller data chunks over time. The present invention modifies the behavior of the RTS 502 in the fifth step to take advantage of a nuance of how many RECs 501 behave in the sixth step 406.

However, before describing the present invention in detail, it is instructive to describe in more detail how a REC 501 requests the tracked image pixel from the RTS 502 in the third step above.

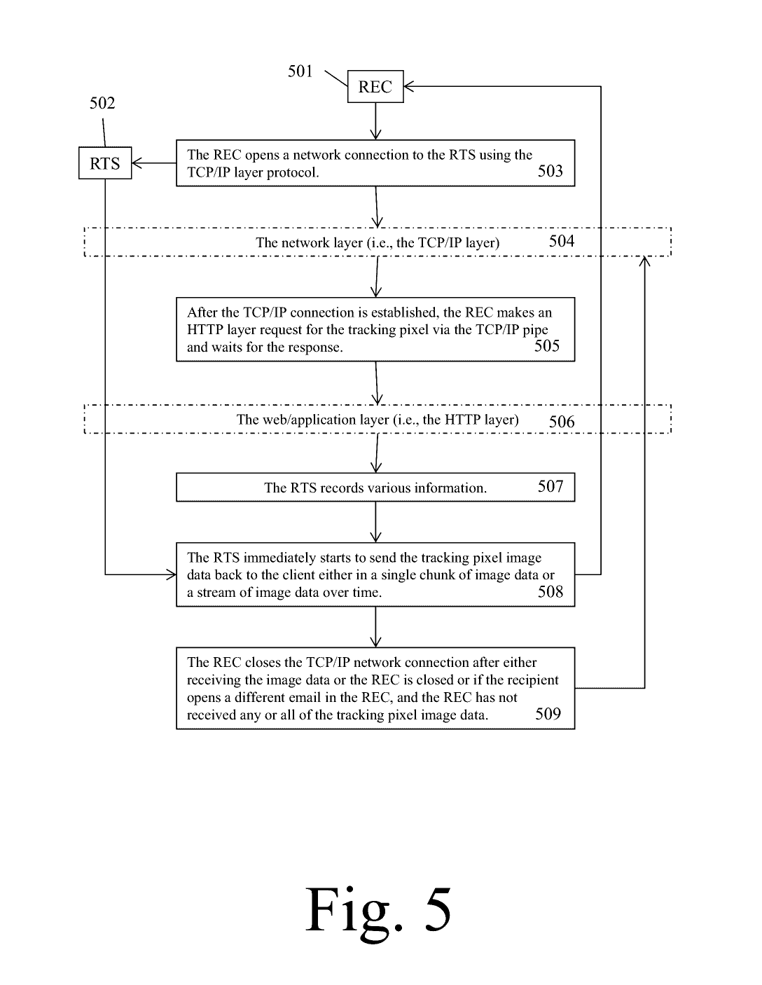

The description can be simplified by breaking the request up into two layers (even though technically there are many other layers such as those described in the OSI model): The network layer 504 (i.e., the TCP/IP layer) and the web/application layer 506 (i.e., the HTTP layer). When an REC 501 makes a request for a pixel, it does the following as illustrated in FIG. 5.

In a first step, the REC 501 opens a network connection to the RTS using the TCP/IP layer protocol 503. (Using a standard TCP/IP 3way handshake). The connection to the server can be done directly, or indirectly through load balancers or proxy servers. This connection can be conceptually visualized as a pipe between the REC and the RTS that application protocols can send information through.

In a second step, after the TCP/IP connection is established, the REC makes an HTTP layer request for the tracking pixel via the TCP/IP pipe and waits for the response. E.g., the REC make a request like “GET /id1234/pixel.png HTTP/1.0” and the client also sends HTTP UserAgent information in the request for the pixel 505.

In a third step, the RTS records various information such as, but not limited to: the UID of the pixel request (located in the HTTP GET request. eg: id1234), the IP address in the TCP/IP handshake or located within specific HTTP headers such as)(Forwarded for etc. e.g., 1.1.1.1, and the UserAgent located in the HTTP GET requests headers 507.

In a fourth step, the RTS 502 immediately starts to send the tracking pixel image data back to the client either in a single chunk of image data or a stream of image data over time 508.

In a fifth step, the REC 501 closes the TCP/IP network connection after either receiving the image data or the REC is closed or if the recipient opens a different email in the REC, and the REC has not received any or all of the tracking pixel image data 509.

Because the tracking pixel is usually very small and RTSs are usually optimized to send the pixels as fast as possible, the entire duration of the steps above is as low as tens of milliseconds. There are many existing methods for measuring the total duration of the request and response using a simple timer based approach. Certain methods can be used to slow down the delivery of image data via streaming in smaller data chunks.

The present invention modifies the RTS 502 to not actually send back an image as in the fourth step described above and in FIG. 5 for the RTS process steps.

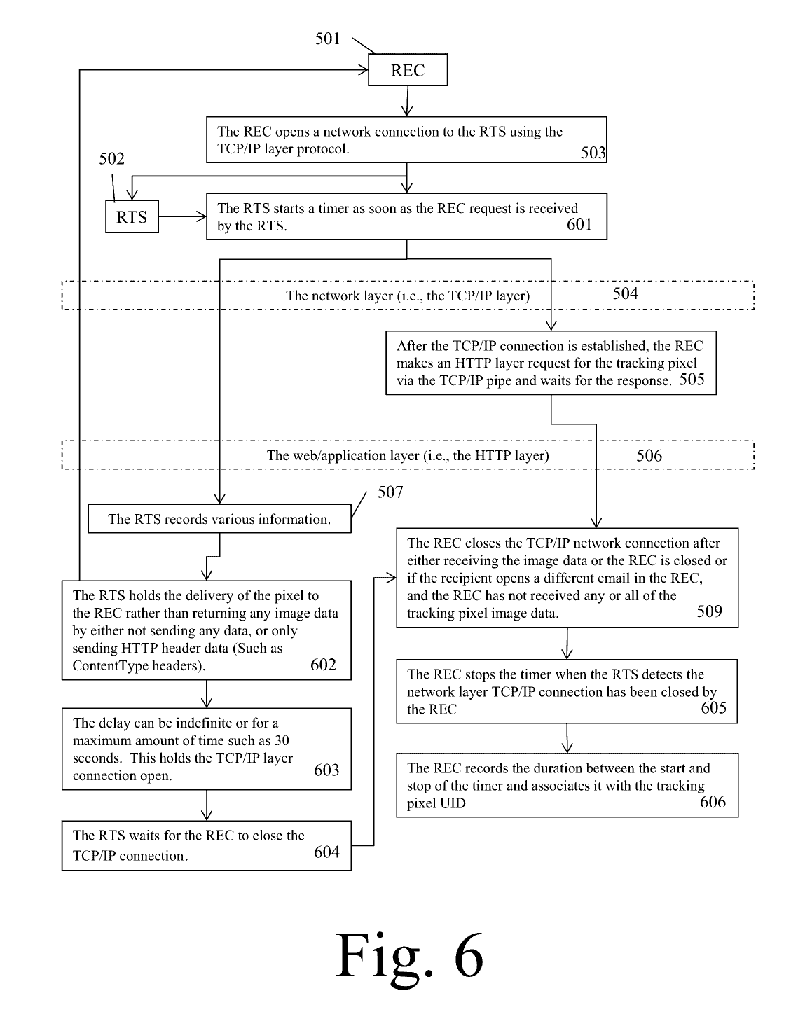

Instead the RTS 502 will follow the flow chart shown in FIG. 6. In a first step, the RTS 502 starts a timer as soon as the REC request is received by the RTS 601. In a second step the RTS 502 holds the delivery of the pixel to the REC rather than returning any image data by either not sending any data, or only sending HTTP header data (Such as ContentType headers) 602. The delay can be indefinite or for a maximum amount of time such as 30 seconds. This holds the TCP/IP layer connection open 603. In a third step the RTS waits for the REC to close the TCP/IP connection as described in the fifth step shown in FIG. 5 and above 604. In a fourth step, the REC stops the timer when the RTS detects the network layer TCP/IP connection has been closed by the REC 605. In a fifth step the REC records the duration between the start and stop of the timer and associates it with the tracking pixel UID 606.

The key method step of the present invention is to have the RTS 502 do the opposite of what the REC 501 is requesting in the HTTP application layer request by not sending any image data. While the request is held open at the HTTP layer 504, the RTS 502 is giving the REC 501 an opportunity to send a signal via the network TCP/IP layer 504 of when the email is no longer open.

Certain email clients such as for GOOGLE's Mail for web may not immediately terminate a TCP/IP layer 504 connection if a user opens a different email message. In this case, duration and other information may not be trackable.

For simplicity, this description above gives examples of IP version 4 addresses such as 1.1.1.1. However, then it should be understood that the present invention can be applied to IP version 6 addresses as well.

If a user opens an email and steps away or reads it longer than the timeouts specified by the TCP/IP protocol, then accuracy of the duration may be limited to the maximum time the server holds the request before the TCP/IP timeout occurs.

The present invention is not limited to email and can potentially be used in the same way on websites where the software client is a web browser rather than email software. In this alternative embodiment, on websites there are other methods such as using JAVASCRIPT to determine the duration of a visit to a website. However, the method of the present invention can be adapted to and would be useful in situations where a web browser has JAVASCRIPT disabled. In this situation, the present invention would provide an alternative means for obtaining the tracking information previously lost by being unobtainable by the inactivation of JAVASCRIPT, rather than a loss of the information completely.

The system is set to run on a computing device or mobile electronic device. A computing device or mobile electronic device on which the present invention can run would be comprised of a CPU, Hard Disk Drive, Keyboard, Monitor, CPU Main Memory and a portion of main memory where the system resides and executes. Any general-purpose computer, smartphone, or other mobile electronic device with an appropriate amount of storage space is suitable for this purpose. Computer and mobile electronic devices like these are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for determining the duration of time an email has been open on a recipients computer or mobile electronic device recorded on non-transitory computer-readable medium and capable of execution by a computer, said method comprising the steps of:
receiving a request containing a unique id for an image file from a client application;
starting a timer at the time of receiving the request;
intentionally not sending any image data back to the client;
stopping the timer upon receiving indication that the network connection has been closed by the client application browser or some other network error; and
recording the time differential from timer start to timer finish into a database.

2. The method of claim 1, wherein the client application is an email client, web browser, or mobile application.

3. The method of claim 1, further comprising the step of:
sending hypertext transfer protocol (HTTP) header information back to indicate to client to wait for an image.

4. The method of claim 1, further comprising the step of:
withholding the delivery of the pixel to the recipient email client (REC) rather than returning any image data by not sending any data; and
achieving general tracking information.

5. A method for determining the duration of time an email has been open on a recipient computer or mobile electronic device recorded on non-transitory computer-readable medium and capable of execution by a computer, said method comprising the steps of:
drafting and sending an email;
embedding a pixel in the email that contains a unique identification number (UID) in the uniform resource locator (URL);
sending the email to a recipient;
opening the email by a recipient;
sending a request to an remote tracking server (RTS) by a REC;
the REC requesting the tracking pixel from the URL;
the RTS starting a timer as soon as the REC request is received by the RTS;
the RTS holding the delivery of the pixel to the REC rather than returning any image data;
the delay holding the transmission control protocol/internet protocol (TCP/IP) layer connection open;
the RTS waits for the REC to close the TCP/IP connection;
the REC stops the timer when the RTS detects the network layer TCP/IP connection has been closed by the REC; and
the REC records the duration between the start and stop of the timer and associates it with the tracking pixel UID.

6. The method of claim 5, wherein the RTS holds the delivery of the pixel to the REC rather than returning any image data by either
not sending any data; or
only sending HTTP header data.

7. The method of claim 5, wherein the RTS holds the delivery of the pixel to the REC rather than returning any image data by not sending any data.

8. The method of claim 5, further comprising the steps of the RTS holding the delivery of the pixel to the REC rather than returning any image data by not sending any data; and
achieving general tracking information.

9. The method of claim 5, wherein the RTS holds the delivery of the pixel to the REC rather than returning any image data by only sending HTTP header data.

10. The method of claim 5, wherein the HTTP header data is ContentType headers.

11. The method of claim 5, wherein the delay is indefinite.

12. The method of claim 5, wherein the delay is for a maximum amount of time such as 30 seconds.
